(19) United States
(12) Patent Application Publication
(10) Pub. No.: US 2022/0390263 A1
(43) Pub. Date: Dec. 8, 2022

(54) DISTURBANCE ESTIMATION DEVICE, DISTURBANCE ESTIMATION METHOD, AND PROGRAM

(71) Applicant: MITSUBISHI HEAVY INDUSTRIES, LTD., Tokyo (JP)

(72) Inventors: Takaharu HIROE, Tokyo (JP); Kazunari IDE, Tokyo (JP); Ryo SASE, Tokyo (JP)

(21) Appl. No.: 17/737,407

(22) Filed: May 5, 2022

(30) Foreign Application Priority Data
May 31, 2021 (JP) 2021-091155

(51) Int. Cl. G01F 15/00; F23G 5/50

(52) U.S. Cl. CPC G01F 15/00; F23G 5/50

(57) ABSTRACT

A disturbance estimation device includes: an acquisition unit configured to acquire a measurement value measured by a sensor provided in a controlled object; and an estimating unit configured to calculate a variance-covariance matrix of a measurement vector including the measurement value as an element, perform singular value decomposition on the variance-covariance matrix to calculate a singular vector of a maximum singular value, and estimate a disturbance that occurs in the controlled object based on the singular vector.

### CROSS-REFERENCE TO RELATED APPLICATIONS

This application claims the benefit of priority to Japanese Patent Application Number 2021-091155 filed on May 31, 2021. The entire contents of the above-identified application are hereby incorporated by reference.

### TECHNICAL FIELD

The present disclosure relates to a disturbance estimation device, a disturbance estimation method, and a program.

### RELATED ART

Waste power generation is economically important. With such, power is generated using steam generated through heat recovery during combustion of garbage with a boiler installed in a garbage incinerator, meaning that garbage is provided with an additional value as a fuel to be something more than just a waste. An effective way to increase the additional value of garbage as a fuel is to stabilize the amount of steam generated, so that power can be generated as planned. JP 2019-178850 A discloses a control method focusing on moisture in the waste, as a factor that causes variation in the amount of heat generated by a garbage incinerator for waste power generation. Specifically, the amount of waste supplied to an incinerator per unit time is adjusted based on variation in the moisture percentage in the waste. More specifically, with the technique disclosed in JP 2019-178850 A, a disturbance to the steam flow rate is estimated based on the moisture content in the waste, and the amount of garbage supplied and the like are adjusted before the controlled variable (the steam flow rate) is affected by the disturbance, to achieve stable power generation.

JP 5996762 B discloses a method of controlling combustion in a garbage incinerator, including estimating the amount of heat generated per unit waste supply amount. However, a calculation for estimating the amount of heat generated per unit waste supply amount requires hours of data, and can only provide an estimated value as a result of averaging over such hours. This means that especially when the property of the waste varies over time, timely calculation of the estimated “amount of heat generated per unit time with the waste” at the current time point cannot be implemented. Thus, power generated may vary due to inaccurate estimation of the amount of steam generated by a boiler (steam flow rate), used for adjusting the waste or combustion air supplied to the incinerator. The technique disclosed in JP 5996762 B includes the following steps: (1) measuring oxygen and moisture component concentrations in exhaust gas with a sensor, and calculating the amount of heat generated with the waste; (2) calculating the amount of steam generated by a boiler based on the amount of heat generated with the waste thus calculated; and (3) controlling the amount of waste, combustion air, or the like supplied to the incinerator based on the amount of steam generated by a boiler, thus calculated. Thus, in JP 5996762 B, the disturbance is estimated based on the variation in the amount of heat generated with the waste, and the combustion control is performed for the garbage incinerator based on the amount of steam generated by a boiler, calculated based on the amount of heat generated representing the disturbance.

### SUMMARY

The control methods disclosed in JP 2019-178850 A and JP 5996762 B are control techniques for stabilizing, based on the characteristics of the garbage incinerator, the controlled variable such as a steam flow rate, even under a situation where the controlled variable varies, and are techniques unique to garbage incinerators. The techniques are not versatile enough to be applied to other target objects through recent machine learning. A versatile method of estimating a disturbance occurring in a controlled object has been called for.

The present disclosure provides a disturbance estimation device, a disturbance estimation method, and a program that can solve the above-described problem.

A disturbance estimation device of the present disclosure includes: an acquisition unit configured to acquire a measurement value measured by a sensor provided in a controlled object; and an estimating unit configured to calculate a variance-covariance matrix of a measurement vector including the measurement value as an element, perform singular value decomposition on the variance-covariance matrix to calculate a singular vector of a maximum singular value, and estimate a disturbance occurring in the controlled object based on the singular vector and the measurement vector.

A disturbance estimation method of the present disclosure includes: acquiring a measurement value measured by a sensor provided in a controlled object; and calculating a variance-covariance matrix of a measurement vector including the measurement value as an element, performing singular value decomposition on the variance-covariance matrix to calculate a singular vector of a maximum singular value, and estimating a disturbance occurring in the controlled object based on the singular vector and the measurement vector.

A non-transitory computer readable storage medium storing a program of the present disclosure causes a computer to perform: acquiring a measurement value measured by a sensor provided in a controlled object; and calculating a variance-covariance matrix of a measurement vector including the measurement value as an element, performing singular value decomposition on the variance-covariance matrix to calculate a singular vector of a maximum singular value, and estimating a disturbance occurring in the controlled object based on the singular vector and the measurement vector.

With the disturbance estimation device, the disturbance estimation method, and the program described above, a disturbance can be estimated.

### BRIEF DESCRIPTION OF DRAWINGS

The disclosure will be described with reference to the accompanying drawings, wherein like numbers reference like elements.

FIG. 1 is a schematic diagram of a control system according to embodiments.

FIG. 2 is a diagram illustrating an example of a functional configuration of a main part of a disturbance estimation device according to a first embodiment.

FIG. 3 is a diagram illustrating an example of disturbance estimation processing according to the first embodiment.

FIG. 4 is a diagram illustrating an example of update timings in processing according to the first embodiment.

FIG. 5 is a diagram illustrating an example of a functional configuration of a main part of a disturbance estimation device according to a second embodiment.

FIG. 6 is a diagram illustrating an example of disturbance estimation processing according to the second embodiment.

FIG. 7 is a diagram illustrating an example of a functional configuration of a main part of a disturbance estimation device according to a third embodiment.

FIG. 8 is a diagram illustrating an example of disturbance estimation processing according to the third embodiment.

FIG. 9 is a diagram illustrating an example of a functional configuration of a main part of a disturbance estimation device according to a fourth embodiment.

FIG. 10 is a diagram illustrating an example of a time difference between a time point when a disturbance has occurred, and a time point when an influence of the disturbance appears in a measurement value, according to the fourth embodiment.

FIG. 11 is a diagram illustrating an example of disturbance estimation processing according to the fourth embodiment.

FIG. 12 is a diagram illustrating an example of a functional configuration of a main part of a disturbance estimation device according to a fifth embodiment.

FIG. 13 is a diagram illustrating an example of disturbance estimation processing according to the fifth embodiment.

FIG. 14 is a diagram illustrating an example of a functional configuration of a main part of a disturbance estimation device according to a sixth embodiment.

FIG. 15 is a diagram illustrating an example of a hardware configuration of the disturbance estimation devices according to the embodiments.

### DESCRIPTION OF EMBODIMENTS

A disturbance estimation device according to embodiments will be described below with reference to the accompanying drawings. In the following description, configurations having the same or similar functions are denoted with the same reference numerals. For such configurations, redundant descriptions may be omitted. An expression “XX or YY” is not limited to one of XX and YY, and may include both XX and YY. The same applies to selection for three or more elements. Note that “XX” and “YY” are any elements (any information for example).

### First Embodiment

### Configuration

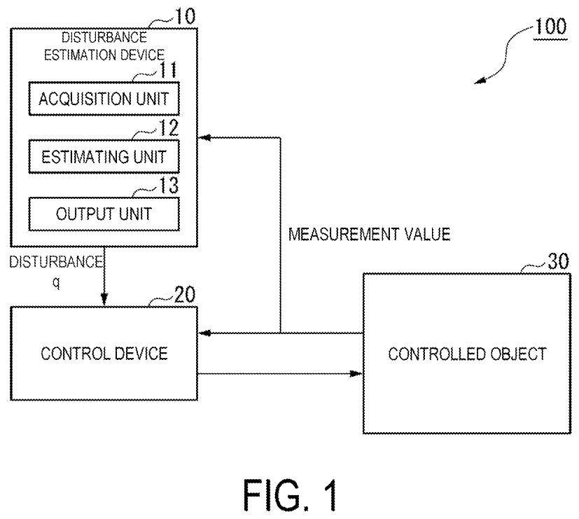

FIG. 1 is a schematic diagram of a control system according to embodiments.

This control system 100 includes a disturbance estimation device 10, a control device 20, and a controlled object 30. The disturbance estimation device 10 estimates a disturbance that affects a controlled variable of the controlled object 30. The disturbance estimation device 10 includes an acquisition unit 11, an estimating unit 12, and an output unit 13. The acquisition unit 11 acquires a measurement value measured by a sensor provided in the controlled object 30. A disturbance that has occurred in the controlled object 30 is expressed as a variation in the measurement value acquired by the acquisition unit 11. The estimating unit 12 uses the measurement value acquired by the acquisition unit 11 to estimate the magnitude of a disturbance q having occurred in the controlled variable. The output unit 13 outputs an estimated value of the disturbance q (hereinafter, referred to as a disturbance q or an estimated value q) to the control device 20.

The control device 20 acquires the disturbance q from the disturbance estimation device 10, and acquires the measurement value measured by the sensor in the controlled object 30. The control device 20 controls the controlled object 30 based on the disturbance q and the measurement value. Examples of the controlled object 30 include: various plants such as garbage incinerators, power plants, and chemical plants; various machines such as marine vessels, gas turbines, steam turbines, and compressors; and the like. Hereinafter, disturbance estimation processing according to the present disclosure will be described with a garbage incinerator as an example of the controlled object 30, but the object to which the embodiments can be applied is not limited to the garbage incinerator.

The measurement value acquired by the control device 20 includes the controlled variable. The control device 20 controls the controlled object 30 to maintain a constant controlled variable, for example. Ideally, the garbage incinerators are operated with a constant flow rate of steam generated, for example. With a constant steam flow rate generated, the incinerator can continuously generate the steam with the maximum capacity, whereby the garbage incinerated amount, that is, processed amount as well as the income obtained by selling the generated power can be maximized. However, a wide variety of types of garbage are collected in a city, meaning that a constant steam flow rate cannot be achieved even when the garbage is supplied into the incinerator at a constant rate in terms of time, for example. According to the technique disclosed in JP 2019-178850 A, the moisture in garbage is measured. According to the technique disclosed in JP 5996762 B, the amount of heat generated per unit mass of garbage is estimated, and a factor that has caused the variation in the amount of heat generated by an incinerator is estimated to be used for adjusting waste and combustion air. A variable such as steam flow rate to be a control target is generally referred to as a controlled variable. A factor that causes unintentional variation in the measurement value of the controlled object including the controlled variable is generally referred to as a disturbance. Typical disturbances in the garbage incinerator include variation in moisture in garbage, and variation in the amount of heat generated per unit mass of garbage. In a macroscopic point of view of such factors, variation in the amount of heat generated by the incinerator as a whole is also a disturbance. The techniques described in JP 2019-178850 A and in JP 5996762 B, are both techniques for estimating a specific disturbance related to variation in combustion speed based on thermological knowledge related to garbage incinerators. On the other hand, the technique of the present embodiment enables the disturbance q to be estimated, without preliminary knowledge, such as thermology for example, for the controlled object. Specifically, a dominant disturbance is estimated from the measurement values obtained from a sensor provided in the controlled object. An example of the estimation procedure of the disturbance q performed by the estimating unit 12 is described below, using an example of a garbage incinerator.

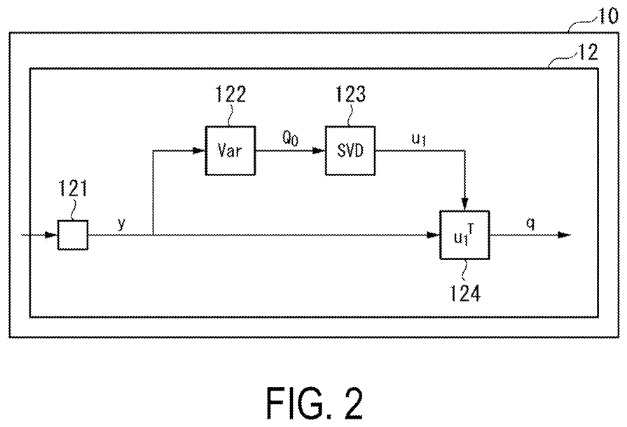

FIG. 2 is a diagram illustrating an example of a functional configuration of a main part of a disturbance estimation device according to a first embodiment.

FIG. 2 illustrates a configuration of the main part of the estimating unit 12 among the components of the disturbance estimation device 10. The estimating unit 12 includes a unit 121 that forms a measurement vector y with m rows and one column including, as an element, a measurement value measured by the sensor in the controlled object 30, a unit 122 that calculates a variance-covariance matrix of the measurement vector y, a unit 123 that performs singular value decomposition on the variance-covariance matrix to calculate a singular vector of the maximum singular value, and a unit 124 that estimates the disturbance q of the controlled object 30 based on the singular vector of the maximum singular value.

### Estimation Procedure of Disturbance

The disturbance is represented by q∈R₁. In the garbage incinerator, the dominant disturbance q is the combustion speed. As the disturbance q varies, a measurement value y∈Rₘ also varies. Both variations are approximated by a linear expression as in Equation (1).

y=c₁×q (1)

In Equation (1), c₁ is a coefficient vector of m rows and 1 column. c₁ represents a response of the measurement vector y as the disturbance q increases. In the garbage incinerator, as the combustion speed increases, the steam flow rate increases, the combustion chamber temperature increases, and the oxygen concentration in exhaust gas decreases. c₁ is a coefficient vector for quantifying an increase or decrease, and its value is determined as follows. First, a variance-covariance matrix Q₀∈R^{m×m} of the measurement vector y, having a measurement value as a column element, is calculated as in Equation (2). In Equation (2), Var is a symbol of variance.

Q₀=Var(y) (2)

Then, the variance-covariance matrix Q₀ is subjected to singular value decomposition (SVD), and a singular vector uᵢ (i=1, 2, . . . , m)∈R^{m} and a singular value σ²ᵢ (i=1, 2, . . . , m)∈R⁺ in Equation (3) are obtained. In accordance with the convention of singular value decomposition, singular values are sorted in order of magnitude. Specifically, σ₁² is a maximum singular value, and σ^{2 m} is a minimum singular value. Symbol T at the upper right represents the transposition of the matrix.

$$\begin{matrix}Equation 1 & \\ [ {u}_{1} {u}_{2} … {u}_{m} ] [ \begin{matrix}{σ}_{1}^{2} & 0 & … & 0 \\ 0 & {σ}_{2}^{2} & & 0 \\ ⋮ & & ⋱ & 0 \\ 0 & 0 & & {σ}_{m}^{2}\end{matrix} ] [ \begin{matrix}{u}_{1}^{⊤} \\ {u}_{2}^{⊤} \\ ⋮ \\ {u}_{m}^{⊤}\end{matrix} ] = {Q}_{0} & ( 3 )\end{matrix}$$

Then, with the disturbance ρᵢ (i=1, 2, . . . , m)ΣR¹ being assumed, a variation in the measurement vector y is represented by the singular vector u and the unknown disturbance ρ, as in Equation (4). Elements of the unknown disturbance ρ are linear independent, that is, Cov (ρᵢ, ρⱼ)=0 if i is not j. Cov is a covariance symbol. The value of u is determined by the singular value decomposition on the variance-covariance matrix Q₀ of the measurement vector y, and thus the value of the unknown disturbance p can be calculated from the measurement vector y.

$$\begin{matrix}Equation 2 & \\ y = [ {u}_{1} {u}_{2} … {u}_{m} ] [ \begin{matrix}{ρ}_{1} \\ {ρ}_{2} \\ ⋮ \\ {ρ}_{m}\end{matrix} ] & ( 4 )\end{matrix}$$

Due to the symmetry of the variance-covariance matrix Q₀, the singular vector u has the property represented by Equation (5).

$$\begin{matrix}Equation 3 & \\ [ {u}_{1} {u}_{2} … {u}_{m} ] [ \begin{matrix}{u}_{1}^{⊤} \\ {u}_{2}^{⊤} \\ ⋮ \\ {u}_{m}^{⊤}\end{matrix} ] = I & ( 5 )\end{matrix}$$

Thus, the disturbance p can be defined as being a positive with both sides of Equation (4) multiplied by u^{T} from the left.

$$\begin{matrix}Equation 4 & \\ [ \begin{matrix}{ρ}_{1} \\ {ρ}_{2} \\ ⋮ \\ {ρ}_{m}\end{matrix} ] = [ \begin{matrix}{u}_{1}^{⊤} \\ {u}_{2}^{⊤} \\ ⋮ \\ {u}_{m}^{⊤}\end{matrix} ] y & ( 6 )\end{matrix}$$

Calculating the variance-covariance matrix of the disturbance p results in Equation (7).

$$\begin{matrix}Equation 5 & \\ \begin{matrix}Var ( [ \begin{matrix}{ρ}_{1} \\ {ρ}_{2} \\ ⋮ \\ {ρ}_{m}\end{matrix} ] ) = [ \begin{matrix}{u}_{1}^{⊤} \\ {u}_{2}^{⊤} \\ ⋮ \\ {u}_{m}^{⊤}\end{matrix} ] Var ( y ) [ {u}_{1} {u}_{2} … {u}_{3} ] \\ = [ \begin{matrix}{σ}_{1}^{2} & 0 & … & 0 \\ 0 & {σ}_{2}^{2} & & 0 \\ ⋮ & & ⋱ & \\ 0 & 0 & & {σ}_{m}^{2}\end{matrix} ]\end{matrix} & ( 7 )\end{matrix}$$

The variance of ρ₁, which is the first element of the unknown disturbance, is the maximum singular value σ₁², as represented by Equation (7). Thus, the largest component of the variance of the measurement vector y can be regarded as being attributed to pi. This is because, due to the property of singular values,

Var(y₁)+Var(y₂)+ . . . +Var(yₘ)=σ₁²+σ₂²+ . . . +σₘ² (8)

holds true. In particular, if σ₁²>>σ₂²+σ₃²+ . . . +σₘ² holds true, approximation as in Equation (8A) below is achieved, and the variation in the measurement vector y is governed by ρ₁.

Equation 6

Var(y₁)+Var(y₂)+ . . . +Var(yₘ)≈σ₁² (8A)

The part related to pi is extracted from Equation (6) to obtain Equation (9) as an estimate equation of the disturbance q.

$$\begin{matrix}Equation 7 & \\ Q \approx {ρ}_{1} = {u}_{1}^{⊤} y & ( 9 )\end{matrix}$$

It has been known that variation in the combustion speed is the dominant disturbance q in the example of the garbage incinerator. The variation in the combustion speed is the dominant disturbance q estimated by the estimating unit 12 using Equation (9) through the procedure described above after the acquisition unit 11 has acquired the measurement value y. The output unit 13 outputs the disturbance q to the control device 20. The control device 20 regards the disturbance q as the variation in the combustion speed, and adjusts the combustion air or the garbage supply to offset the variation. Thus, the garbage incinerator can be operated with the steam flow rate kept constant. It is possible to guess the dominant disturbance for any controlled object, meaning that such object is not limited to the garbage incinerator. For example, the dominant disturbance is tide in a case of automatic steering of marine vessels, and is a road surface slope or the like in a case of vehicle speed control. Such knowledge is obtained through experience, and not with analytical solutions such as equation of motion.

### Operation

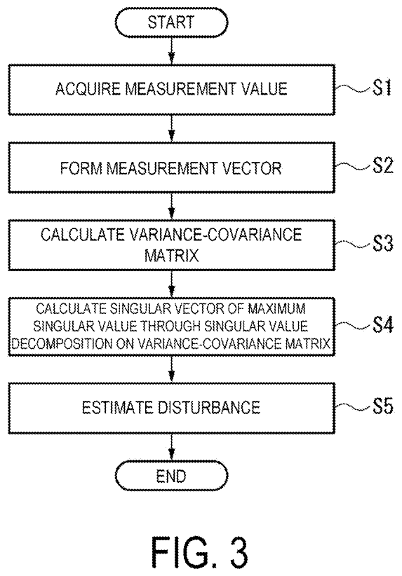

The above-described procedure is illustrated in FIG. 3. FIG. 3 is a diagram illustrating an example of the disturbance estimation processing according to the first embodiment. First of all, the acquisition unit 11 acquires measurement values measured by the sensor provided in the garbage incinerator, such as the steam flow rate, the combustion chamber temperature, and the oxygen concentration in the exhaust gas (step S1). The unit 121 of the estimating unit 12 forms the measurement vector y by using the measurement value acquired by the acquisition unit 11 (step S2). For example, the unit 121 forms the measurement vector y including, as elements, the measurement values of the steam flow rate, the combustion chamber temperature, and the oxygen concentration in the exhaust gas. Next, the unit 122 of the estimating unit 12 calculates the variance-covariance matrix Q₀ as in Equation (2) (step S3). Next, the unit 123 of the estimating unit 12 calculates a singular vector of the maximum singular value through the singular value decomposition on the variance-covariance matrix as in Equation (3) (step S4). Next, the unit 124 of the estimating unit 12 estimates the disturbance q as in Equation (9) (step S5). The estimating unit 12 outputs the disturbance q to the control device 20.

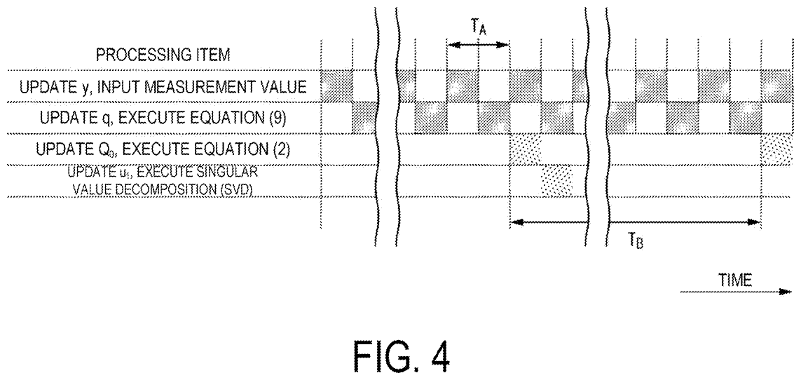

FIG. 4 illustrates relationship between update timings among the measurement vector y, the disturbance q, Q₀, and u₁, in the disturbance estimation processing described above. For example, the measurement vector y is updated at a cycle T_{A} of arrival of new measurement values to the disturbance estimation device 10. Correspondingly, the disturbance q is also updated at the cycle T_{A}. On the other hand, the variance-covariance matrix Q₀ from Equation (2) and u₁ as a result of the singular value decomposition in Equation (3) are updated at a cycle T_{B}. The value of the singular vector u₁ is determined from the variance-covariance matrix, and thus is calculated at the cycle T_{B} of updating the variance-covariance matrix Q₀. The update cycles are determined based on the characteristics of the object. Still, T_{A}<<T_{B} generally holds. In a rare case where the characteristics of the object do not change, the singular vector u₁ may be fixed to a value determined in advance.

According to the present embodiment, the disturbance q affecting the controlled variable can be estimated based on the measurement values measured for the controlled object 30. In many cases, the sensor is provided in the controlled object 30 to measure the controlled variable and physical amounts that affect the controlled variable, whereby the disturbance q can be estimated using measurement values from the existing sensor, without the need for adding a new sensor. Furthermore, the timely estimation of the disturbance q based on the latest measurement value can be achieved, at the cycle T_{A} at which the measurement vector y is obtained as in the example illustrated in FIG. 4. Since only the acquisition of the measurement values by the sensor provided in the controlled object 30 and the execution of the procedure described above are required, a versatile configuration can be achieved that is applicable to disturbance estimation for various controlled objects 30 and does not depend on the characteristics of the controlled object 30.

### Second Embodiment

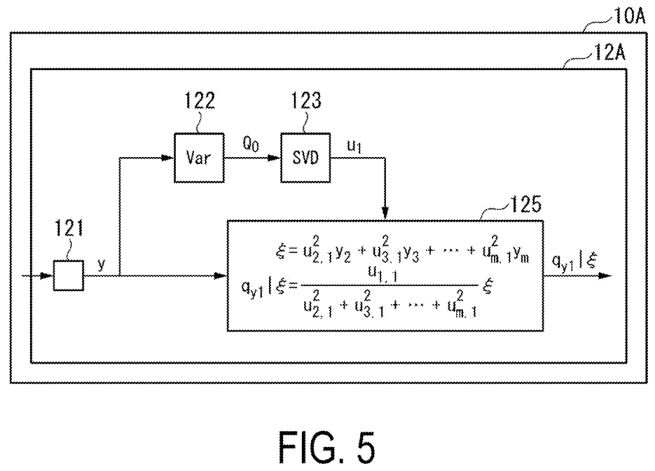

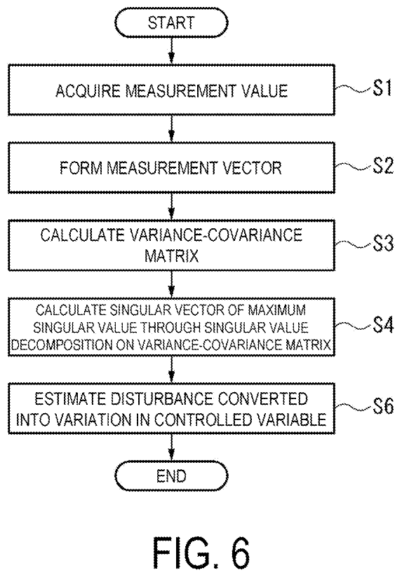

A disturbance estimation device according to a second embodiment will be described with reference to FIGS. 5 and 6.

In the first embodiment, a dominant disturbance (combustion speed, for example) is assumed to be known in advance. For the garbage incinerator, since the combustion speed is known to be the dominant disturbance, meaning that the disturbance q is the variation in the combustion speed calculated with Equation (9), and the amount of combustion air or garbage supplied is adjusted based on the variation in the combustion speed. In the second embodiment, the disturbance converted into a variation in a controlled variable is estimated. In this way, the method that is similar to that in the first embodiment can be applied even if the dominant disturbance is not known in advance. An example of the controlled variable in a case of the garbage incinerator is the steam flow rate. Thus, the estimation of the disturbance converted into the variation in the controlled variable is estimation of the variation in the combustion speed converted into the variation in the steam flow rate affected by the variation in the combustion speed. The estimation with the conversion into the variation in the controlled variable has the following advantages. That is, the disturbance q can be estimated without knowing that the variation in the combustion speed is the dominant disturbance. In addition, control on the garbage incinerator needs no conversion of the magnitude of the disturbance q (combustion speed) into the steam flow rate, which is the controlled variable. Thus, the steam flow rate can be directly used for the control.

### Configuration

FIG. 5 is a diagram illustrating an example of a functional configuration of a main part of the disturbance estimation device according to the second embodiment.

A disturbance estimation device 10A according to the second embodiment includes an estimating unit 12A instead of the estimating unit 12. The measurement values acquired by the acquisition unit 11 of the second embodiment include a controlled variable. The following description is given assuming that the controlled variable is arranged as a first element of the measurement vector y.

The estimating unit 12A according to the second embodiment includes, instead of the unit 124, a unit 125 that estimates the disturbance to the target object as the variation in the controlled variable, based on the singular vector of the maximum singular value. As in the first embodiment, the estimating unit 12A calculates the variance-covariance matrix Q₀ of the measurement vector y with Equation (2), and performs the singular value decomposition as in Equation (3) on the variance-covariance matrix Q₀. Then, the estimating unit 12A calculates the singular vector uᵢ (i=1, 2, . . . , m) and the singular value σ²ᵢ (i=1, 2, . . . , m). Equation (6A) is the first row extracted from Equation (6).

$$\begin{matrix}Equation 8 & \\ \begin{matrix}{ρ}_{1} = {u}_{1}^{⊤} [ \begin{matrix}{y}_{1} \\ {y}_{2} \\ ⋮ \\ {y}_{m}\end{matrix} ] \\ = {u}_{1 , 1} {y}_{1} + {u}_{1 , 2} {y}_{2} + … + {u}_{1 , m} {y}_{m} \\ ( {u}_{1 , 2} {y}_{2} + … + {u}_{1 , m} {y}_{m} ≡ ξ ) \\ = {u}_{1 , 1} {y}_{1} + ξ\end{matrix} & ( 6 A )\end{matrix}$$

Here, u₁, (j=1, 2, . . . , m) is the j-th element of the singular vector u₁ for the maximum singular value. If the maximum singular value corresponding to the first element (controlled variable) is dominant, that is, if σ₁²>>σ₂²+σ₃²3+ . . . +σ^{2m} holds true, the measurement vector y is approximated as in Equation (10A).

$$\begin{matrix}Equation 9 & \\ [ \begin{matrix}{y}_{1} \\ {y}_{2} \\ ⋮ \\ {y}_{m}\end{matrix} ] \approx [ \begin{matrix}{u}_{1 , 1} \\ {u}_{1 , 2} \\ ⋮ \\ {u}_{1 , m}\end{matrix} ] {ρ}_{1} & ( 10 A )\end{matrix}$$

In Equation (6A), ζ is represented as in Equation (11) with the dominant ρ₁.

$$\begin{matrix}Equation 10 & \\ \begin{matrix}ξ \vert {ρ}_{1} = {u}_{1 , 2} {y}_{2} + {u}_{1 , 3} {y}_{3} + … + {u}_{1 , m} {y}_{m} \\ = {u}_{1 , 2} {u}_{1 , 2} {ρ}_{1} + {u}_{1 , 3} {u}_{1 , 3} {ρ}_{1} + … + {u}_{1 , m} {u}_{1 , m} {ρ}_{1} \\ = ( {u}_{1 , 2}^{2} + {u}_{1 , 3}^{2} + … + {u}_{1 , m}^{2} ) {ρ}_{1}\end{matrix} & ( 11 )\end{matrix}$$

Here, ζ|ρ₁ indicates when the input condition is ρ₁.

Likewise, the controlled variable is represented as follows with ρ₁.

y₁|ρ₁=u₁₁ρ₁ (12)

Here, y₁|ρ₁ indicates y₁ when the input condition is ρ₁. As the value of ζ is determined according to Equation (12), the disturbance converted into the variation in the controlled variable, which is denoted by is represented by Equation (13) below.

$$\begin{matrix}Equation 11 & \\ \begin{matrix}{q}_{{y}_{1}} \vert ξ = {y}_{1} \vert ξ \\ = \frac{{u}_{1 , 1}}{{u}_{1 , 2}^{2} + {u}_{1 , 3}^{2} + … + {u}_{1 , m}^{2}} ξ\end{matrix} & ( 13 )\end{matrix}$$

### Operation

The above-described procedure is illustrated in FIG. 6. FIG. 6 is a diagram illustrating an example of the disturbance estimation processing according to the second embodiment. First of all, the acquisition unit 11 acquires measurement values measured by the sensor provided in the garbage incinerator (step S1). The measurement values include the controlled variable. Next, the unit 121 of the estimating unit 12A forms the measurement vector y (step S2). The unit 121 forms the measurement vector y with the controlled variable being the first element. Next, the unit 122 of the estimating unit 12A calculates the variance-covariance matrix Q₀ as in Equation (2) (step S3). Next, the unit 123 of the estimating unit 12A calculates a singular vector of the maximum singular value through the singular value decomposition on the variance-covariance matrix as in Equation (3) (step S4). Next, the unit 125 of the estimating unit 12A estimates the disturbance q_{y1}|ζ converted into the variation in the controlled variable as in Equation (13) (step S6). The estimating unit 12A outputs the disturbance q_{y1}|ζ to the control device 20.

With the present embodiment, the following effects can be achieved in addition to the effects achieved by the first embodiment. Specifically, the estimated value q_{y1}|ζ of the disturbance q converted into the variation in the controlled variable can be calculated based on the measurement value measured in the controlled object 30, even if the disturbance is unknown. For example, as in the first embodiment, the measurement vector y and the disturbance q_{y1}|ζ are updated at the cycle T_{A}. On the other hand, the value of the singular vector u₁ is determined from the variance-covariance matrix Q₀, and thus is calculated at the cycle T_{B} of updating the variance-covariance matrix Q₀. In a case where the characteristics of the object do not change, the singular vector u₁ may be fixed to a value determined in advance.

### Third Embodiment

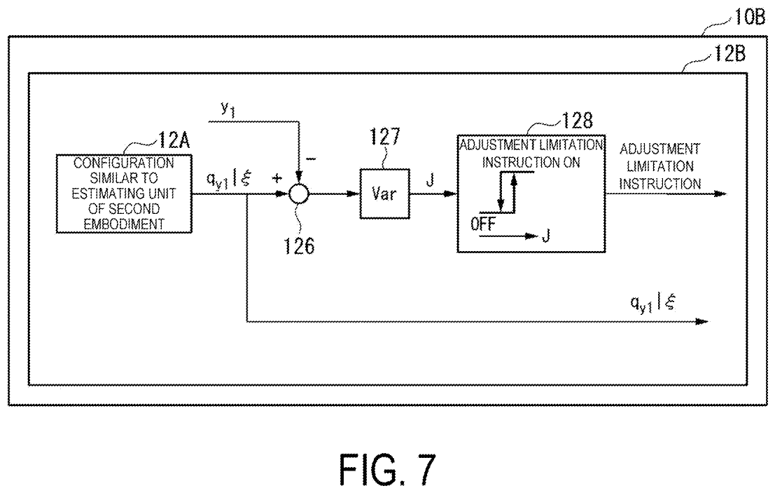

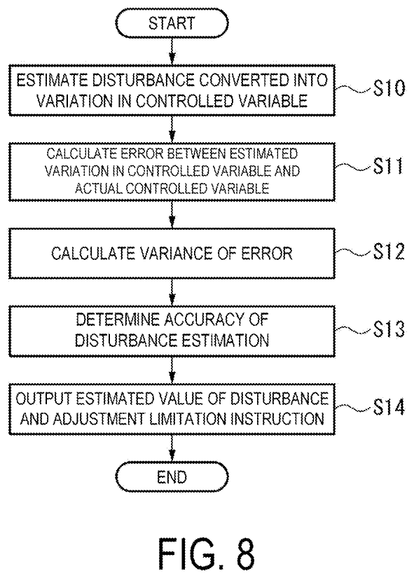

A disturbance estimation device according to a third embodiment will be described with reference to FIGS. 7 and 8.

In the third embodiment, the estimated value q_{y1}|ζ of the disturbance estimated as the variation in the controlled variable is compared with a measured value y₁ of the controlled variable, to determine the accuracy of the disturbance estimation. If the accuracy is low, the control device 20 does not perform the adjustment for offsetting the disturbance. In the example of the garbage incinerator, if a difference between the estimated variation in the steam flow rate and the actual steam flow rate is small, the variation is offset by adjusting the supply of the combustion air or the garbage supply based on the variation in the estimated steam flow rate. On the other hand, if the difference between the estimated variation in the steam flow rate and the actual steam flow rate is large, the adjustment is not performed.

### Configuration

FIG. 7 is a diagram illustrating an example of a functional configuration of a main part of the disturbance estimation device according to the third embodiment.

A disturbance estimation device 10B according to the third embodiment includes an estimating unit 12B instead of the estimating unit 12. The estimating unit 12B calculates the estimated value q_{y1}|ζ through the processing described in the second embodiment, and determines the accuracy of the estimated value q_{y1}|ζ. In addition to the configuration of the estimating unit 12A according to the second embodiment, the estimating unit 12B includes a unit 126 that calculates an error between the estimated variation in the controlled variable and the actual controlled variable, a unit 127 that calculates variance of the error calculated, and a unit 128 that determines the accuracy of the disturbance estimation based on the variance of the error. The measurement values acquired by the acquisition unit 11 of the second embodiment include a controlled variable. The following description is given assuming that the controlled variable is arranged as a first element of the measurement vector y. The output unit 13 of the third embodiment outputs the result of determining the accuracy of the disturbance estimation (adjustment limitation instruction), in addition to the estimated value q_{y1}|ζ.

The estimating unit 12B acquires the estimated value q_{y1}|ζ of the estimated variation in the controlled variable (steam flow rate, for example) and an actual controlled variable y₁, and calculates the variance of the difference between the estimated value q_{y1}|ζ of the variation and the controlled variable y₁ using the following Equation (14).

J=Var(y₁−q_{y1}|ζ) (14)

The estimating unit 12B sets the adjustment limitation instruction to OFF when the variance J is smaller than a predetermined threshold value, and sets the adjustment limitation instruction to ON when the variance J is larger than the predetermined threshold value. The output unit 13 outputs the estimated value q_{y1}|ζ calculated by the estimating unit 12B and the adjustment limitation instruction to the control device 20. The control device 20 performs the adjustment to offset the disturbance when the adjustment limitation instruction is OFF (when the variance J is smaller than the threshold value). For example, in the case of garbage incinerators, the supplied amount of the garbage or combustion air is adjusted, to suppress the variation (the estimated value q_{y1}|ζ) of the steam flow rate. When the adjustment limitation instruction is ON (when the variance J is larger than the threshold value), the adjustment to offset the disturbance is not performed.

### Operation

The above-described procedure is illustrated in FIG. 8. FIG. 8 is a diagram illustrating an example of the disturbance estimation processing according to the third embodiment. First of all, the estimating unit 12B estimates the disturbance q_{y1}|ζ converted into the variation in the controlled variable, through the processing described in the second embodiment (step S10). Next, the unit 126 calculates the estimated variation in the controlled variable, that is, an error between the disturbance q_{y1}|ζ and a controlled variable y₁ (step S11). Next, the unit 127 calculates the variance J of the error calculated in step S11 (step S12). Next, the unit 128 determines the accuracy of the estimation of the disturbance q_{y1}|ζ, based on the variance J of the error calculated in step S12 (step S13). The unit 128 determines that the estimation is inaccurate when the variance J is larger than a predetermined threshold value, and determines that the estimation is accurate when the variance J is smaller than the predetermined threshold value. As illustrated in FIG. 7, a hysteresis width may be provided for this determination. With the hysteresis width provided, the measurement error or variation in the controlled variable y₁ can be absorbed, whereby stable control can be performed. The unit 128 sets the adjustment limitation instruction to ON when the estimation is determined to be inaccurate, and sets the adjustment limitation instruction to OFF when the estimation is determined to be accurate. The estimating unit 12B outputs the estimated value q_{y1}|ζ of the disturbance and the adjustment limitation instruction (ON or OFF) to the control device 20 (step S14).

In step S13, when a situation where the adjustment limitation instruction is ON continues, the estimating unit 12B may attempt to increase the accuracy, such as increasing the frequency of updating Q₀ and u₁ described with reference to FIG. 4. When the accuracy does not increase despite such an attempt, a measurement value may be reselected that is used as a second element or after in the measurement vector y used for calculating the estimated value q_{y1}|ζ.

With the present embodiment, in addition to the effects achieved by the second embodiment, the controlled object 30 can be controlled while checking the accuracy of the disturbance estimated value q_{y1}|ζ. Furthermore, the control device 20 is provided with the function of automatically switching, based on the value of the adjustment limitation instruction, between the executing and stopping of the adjustment based on the disturbance estimated value q_{y1}|ζ, whereby the accuracy of control by the control device 20 can be ensured.

### Fourth Embodiment

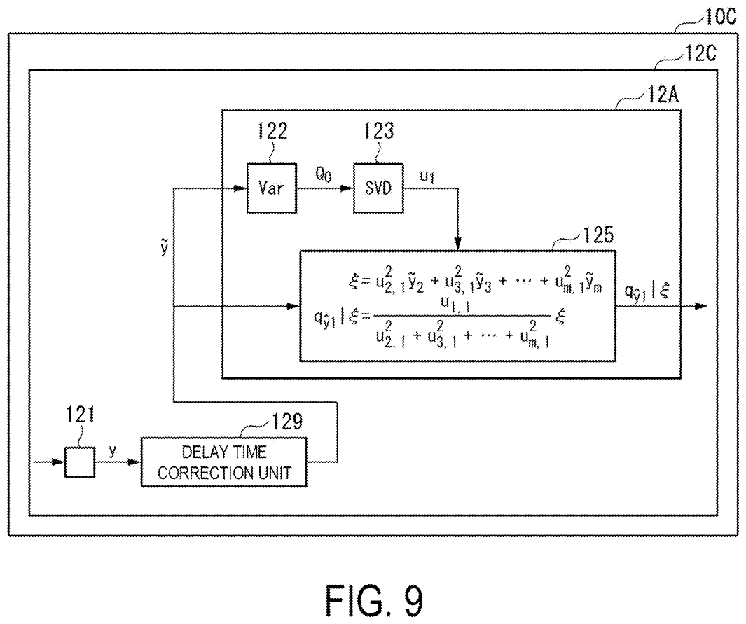

A disturbance estimation device 10C according to a fourth embodiment will be described with reference to FIGS. 9 to 11.

Generally, a disturbance that has occurred appears as a variation in a controlled variable or a measurement value after a time delay. An example is considered where, in a garbage incinerator, it is assumed that an influence of a disturbance as a change in the combustion speed appears in the temperature in the furnace 10 seconds after the occurrence of the disturbance, for example. Furthermore, it is assumed that the influence appears as a variation in the steam flow rate 300 seconds after the occurrence, for example. More specifically, an influence of a change in the combustion speed that has occurred at a time point t for example on the internal furnace temperature appears at a time point t+10, and an influence of the change appears as a variation in the steam flow rate at a time point t+300. Thus, in this case, the variation in the combustion speed involves a response time difference of 290 seconds between the internal furnace temperature and the steam flow rate. If this difference is known, the measurement vector y should be formed with the 290-second time difference therebetween. For example, in a case where the measurement vector y includes the steam flow rate and the internal furnace temperature, the steam flow rate at the time point t and the internal furnace temperature at a time point t-290 are used as elements of a measurement vector at the time point t. When the value of the delay time is unknown, a plurality of different values of delay time may be set. For example, in the example described above, the elements of the measurement vector y are the steam flow rate at the time point t and the internal furnace temperature at the time point t-290. The elements of the measurement vector y may further include the internal furnace temperature at a time point t-350, the internal furnace temperature at a time point t-320, the internal furnace temperature at a time point t-260, and the like.

FIG. 9 is a diagram illustrating an example of a functional configuration of a main part of the disturbance estimation device according to the fourth embodiment.

FIG. 9 illustrates a configuration of the fourth embodiment combined with the second embodiment. An estimating unit 12C of the fourth embodiment includes a delay time correction unit 129 in addition to the configuration of the second embodiment. The delay time correction unit 129 stores, for each element of the measurement vector y, a measurement value measured in the past and a delay time in association with each other. For example, when the measurement vector y includes the steam flow rate and the internal furnace temperature, the delay time correction unit 129 stores, at the time point t, the measurement value of the internal furnace temperature 290 seconds before acquired by the acquisition unit 11, and the fact that the internal furnace temperature is delayed by 290 seconds from the steam flow rate in association with each other. The delay time correction unit 129 acquires the measurement vector y, corrects the delay time for each element of the measurement vector using the value of the delay time stored therein, and outputs a delay-time-corrected measurement vector y^{˜}. In the fourth embodiment, the estimating unit 12C estimates the disturbance based on the delay-time-corrected measurement vector y^{˜}, instead of the measurement vector y.

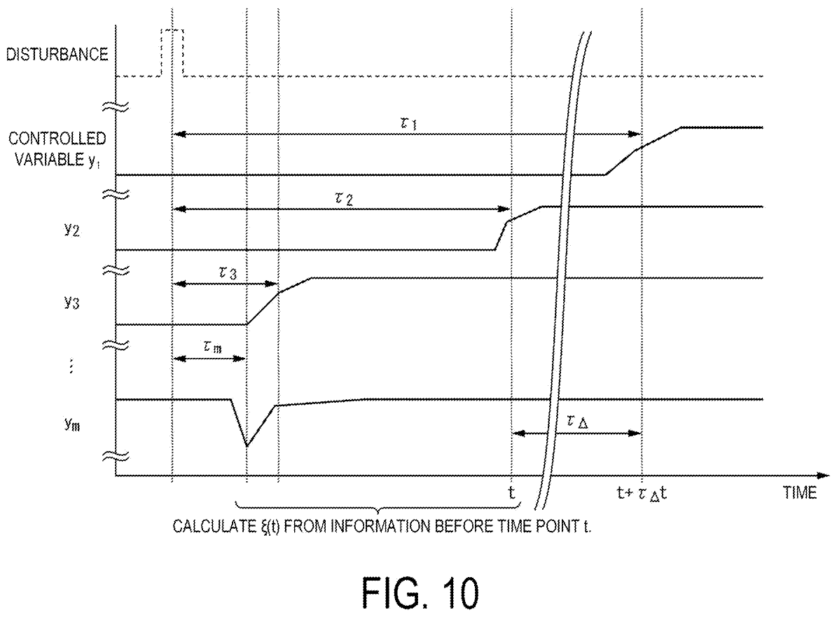

The time correction is described further in detail with reference to FIG. 10. FIG. 10 is a diagram illustrating an example of a time difference between a time point when a disturbance has occurred, and a time point when an influence of the disturbance appears in a measurement value. FIG. 10 illustrates a time period until an element of the measurement vector y responds to a disturbance that has occurred, under conditions that the measurement vector y includes m elements and the delay time of each of the elements is defined as τᵢ (i=1, 2, . . . , m). Here, for ease of explanation, the elements of the measurement vector y^{˜} are arranged in descending order of the length of the delay time. The controlled variable is the final output from a facility such as the garbage incinerator, and thus generally has the longest delay time among the elements of the measurement vector y^{˜}. Since the disturbance estimation is for correcting the variation in the controlled variable, there is no point in using an element with a slower response than the controlled variable for the disturbance estimation. All things considered, it is only logical that the controlled variable has the longest delay time among the elements of the measurement vector y. Calculation of ζ in Equation (6A) at the time point t is considered. Information before the time point t is used for the calculation of ζ as illustrated in FIG. 10. The influence of the disturbance appears in the controlled variable y₁ at a time point after τ_{A}=τ₂−τ₁ from the occurrence of the disturbance. The delay-time-corrected measurement vector y^{˜} can be expressed as in the following Equation (15), using the delay time.

$$\begin{matrix}Equation 12 & \\ [ \begin{matrix}{\tilde{y}}_{1} ( t ) \\ {\tilde{y}}_{2} ( t ) \\ {\tilde{y}}_{3} ( t ) \\ ⋮ \\ {\tilde{y}}_{m} ( t )\end{matrix} ] = [ \begin{matrix}{\hat{y}}_{1} ( t + {τ}_{1} - {τ}_{2} ) \\ {y}_{2} ( t + {τ}_{2} - {τ}_{2} ) \\ {y}_{3} ( t + {τ}_{3} - {τ}_{2} ) \\ ⋮ \\ {y}_{m} ( t + {τ}_{m} - {τ}_{2} )\end{matrix} ] = [ \begin{matrix}{\hat{y}}_{1} ( t + {τ}_{Δ} ) \\ {y}_{2} ( t ) \\ {y}_{3} ( t + {τ}_{3} - {τ}_{2} ) \\ ⋮ \\ {y}_{m} ( t + {τ}_{m} - {τ}_{2} )\end{matrix} ] & ( 15 )\end{matrix}$$

Using this delay-time-corrected measurement vector y^{˜}, the variance-covariance matrix Q₀ is obtained, and the singular vector u thereof is further calculated. Since {y^{˜}₂, y^{˜}₃, . . . , y^{˜}ₘ} at the time point t are a current value or a past value, the estimating unit 12C calculates ζ|ρ₁ with Equation (11) and calculates a disturbance q_{y\hat{ }1}|ζ with Equation (13), using these values. The disturbance q_{y\hat{ }1}|ζ is a predicted variation in the controlled variable (steam flow rate for example) at a time point t+τ_{Δ} predicted at the time point t. Since the future value can be predicted, such a value may be displayed on an operation control panel or the like of the garbage incinerator to help the operation control.

### Operation

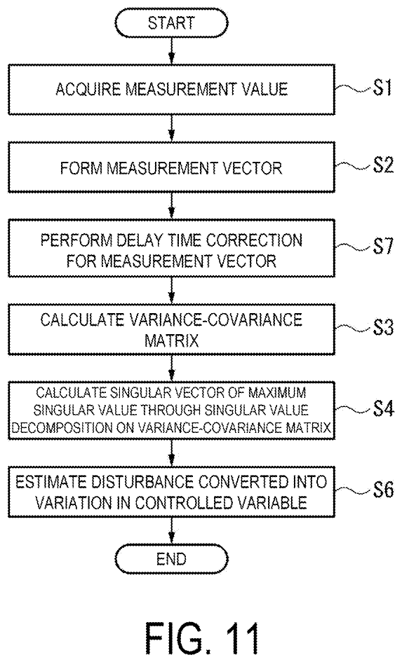

The above-described procedure is illustrated in FIG. 11. FIG. 11 is a diagram illustrating an example of the disturbance estimation processing according to the fourth embodiment. First of all, the acquisition unit 11 acquires measurement values measured by the sensor provided in the garbage incinerator, such as the steam flow rate, the combustion chamber temperature, and the oxygen concentration in the exhaust gas (step S1). Next, the unit 121 of the estimating unit 12C forms the measurement vector y (step S2). Next, the delay time correction unit 129 of the estimating unit 12C acquires the measurement vector y, and outputs the delay-time-corrected measurement vector y^{˜} as a result of correcting the delay time for each element (step S7). Subsequent processing is the same as in the second embodiment. That is, the unit 122 of the estimating unit 12C calculates the variance-covariance matrix Q₀ as in Equation (2) (step S3). Next, the unit 123 of the estimating unit 12C calculates a singular vector of the maximum singular value through the singular value decomposition on the variance-covariance matrix as in Equation (3) (step S4). Next, the unit 125 of the estimating unit 12C estimates the disturbance q_{y\hat{ }1}|ζ converted into the variation in the controlled variable as in Equation (13) (step S6). The estimating unit 12C outputs the estimated value (predicted value) of the disturbance q_{y\hat{ }1}|ζ to the control device 20.

With the fourth embodiment, since the delay time until the influence of the disturbance appears in each measurement value is corrected, in addition to the effects achieved by the second embodiment, the accuracy of the disturbance estimation can be improved. The embodiment that can be combined with the fourth embodiment is not limited to the second embodiment, and the first embodiment and the third embodiment can also be combined. With the fourth embodiment combined with the second embodiment and the third embodiment, future controlled variables can be predicted.

### Fifth Embodiment

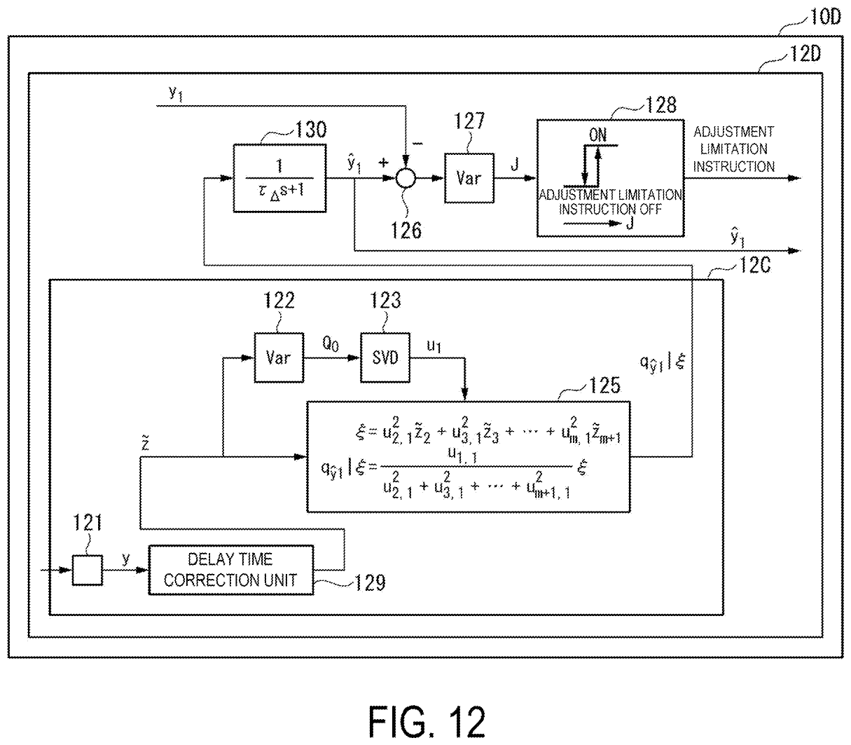

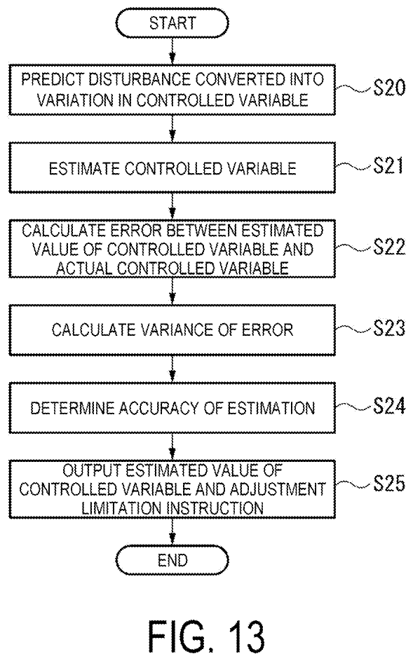

A disturbance estimation device 10D according to a fifth embodiment will be described with reference to FIGS. 12 and 13.

In the fourth embodiment, the predicted value of variation in the controlled variable due to a disturbance is estimated. In the fifth embodiment, the fourth embodiment and the third embodiment are combined to determine the accuracy of the prediction. When the prediction accuracy is determined to be low, the control device 20 does not perform the adjustment to offset the disturbance, to avoid the negative impact of the error. In the example of the garbage incinerator, if a difference between the predicted variation in the steam flow rate and the actual steam flow rate is small, the control device 20 offsets the variation by adjusting the supply of the combustion air or the garbage supply based on the predicted variation in the steam flow rate. On the other hand, if the difference between the predicted variation in the steam flow rate and the actual steam flow rate is large, the control device 20 does not perform the adjustment.

### Configuration

FIG. 12 is a diagram illustrating an example of a functional configuration of a main part of the disturbance estimation device according to the fifth embodiment.

The disturbance estimation device 10D according to the fifth embodiment includes an estimating unit 12D instead of the estimating unit 12. The estimating unit 12D calculates the estimated value q_{y\hat{ }1}|ζ through processing similar to that described in the fourth embodiment as described below, and based on the variance of a difference from the actual controlled variable (steam flow rate for example) y₁, determines the accuracy of the estimated value q_{y\hat{ }1}|ζ. In addition to the configuration of the estimating unit 12C according to the fourth embodiment and the units 126 to 128 according to the third embodiment, the estimating unit 12D includes a unit 130 that estimates the controlled variable from a variation in the controlled variable based on the delay time until the influence of the disturbance appears in the controlled variable and the predicted value of the disturbance. The measurement values acquired by the acquisition unit 11 of the second embodiment include a controlled variable. The output unit 13 of the fifth embodiment outputs the predicted value y\hat{ }₁ of the controlled variable and the result of the determination on the prediction accuracy of the predicted value of the controlled variable (adjustment limitation instruction).

In the fifth embodiment, the delay-time-corrected measurement vector, as described in the fourth embodiment, is formed as in Equation (16).

$$\begin{matrix}Equation 13 & \\ [ \begin{matrix}{\tilde{z}}_{1} ( t ) \\ {\tilde{z}}_{2} ( t ) \\ {\tilde{z}}_{3} ( t ) \\ \begin{matrix}{\tilde{z}}_{4} ( t ) \\ ⋮\end{matrix} \\ {\tilde{z}}_{m + 1} ( t )\end{matrix} ] = [ \begin{matrix}{y}_{1} ( t + {τ}_{Δ} ) \\ {y}_{1} ( t ) \\ {y}_{2} ( t ) \\ \begin{matrix}{y}_{3} ( t + {τ}_{3} - {τ}_{2} ) \\ ⋮\end{matrix} \\ {y}_{m} ( t + {τ}_{m} - {τ}_{2} )\end{matrix} ] & ( 16 )\end{matrix}$$

A measurement vector z^{˜} has a controlled variable y₁(t) added as the second element of the measurement vector y^{˜}. The variance-covariance matrix Q₀ of the measurement vector z^{˜} is obtained, and the singular vector u thereof is further calculated. At the time point t, {z^{˜}₂, z^{˜}₃, . . . , z^{˜}ₘ₊₁} are a current value or a past value, and are used for calculating ζ with Equation (17).

Equation 14

ζ=u_{2,1}²\tilde{z}₂+u_{3,1}²\tilde{z}₃+ . . . +u_{m+1,1}²\tilde{z}ₘ₊₁ (17)

From ζ, as in Equation (18), the predicted value of that is, the predicted value at a time point t+y₁ is obtained.

$$\begin{matrix}Equation 15 & \\ \begin{matrix}{q}_{{\tilde{z}}_{1}} \vert ξ ( t ) = {q}_{{\hat{y}}_{1}} \vert ξ ( t ) \\ = \frac{{u}_{1 , 1}}{{u}_{1 , 2}^{2} + {u}_{1 , 3}^{2} + … + {u}_{m + 1 , 1}^{2}} ξ\end{matrix} & ( 18 )\end{matrix}$$

A predicted value q_{z˜1}|ζ(t) of the disturbance is q_{y\hat{ }1}|ζ(t), and is the predicted value of the controlled variable y₁(t+τ_{Δ}) at the time point t. A predicted value y₁(t+τ_{Δ}) is described as y\hat{ }₁(t+τ_{Δ}) to be distinguished from the actual measurement value. An increment of the predicted value between the time point t and the time point t+τ_{Δ} is approximated with time derivative τ_{Δ} × the predicted value, whereby Equation (19) is obtained.

$$\begin{matrix}[ Equation 16 ] & \\ {q}_{{\hat{y}}_{1}} \vert ξ ( t ) = {\hat{y}}_{1} ( t + {τ}_{Δ} ) \approx {\hat{y}}_{1} ( t ) + {τ}_{Δ} \frac{d}{dt} {\hat{y}}_{1} ( t ) & ( 19 )\end{matrix}$$

From Equation (19), a differential equation indicating a change in the predicted value over time is obtained as in Equation (20).

$$\begin{matrix}[ Equation 17 ] & \\ \frac{d}{dt} {\hat{y}}_{1} ( t ) = \frac{{q}_{{\hat{y}}_{1}} \vert ξ ( t ) - {\hat{y}}_{1} ( t )}{{τ}_{Δ}} & ( 20 )\end{matrix}$$

Through time numerical integration of Equation (20), an estimated value y\hat{ }1(t) of the controlled variable at the current time point t can be obtained based on the predicted value q_{y\hat{ }1}|ζ(t) of the disturbance. In the actual implementation, Equation (20) can be easily calculated with a primary delay filter with a time constant τ_{Δ} and gain 1 as in Equation (21).

$$\begin{matrix}[ Equation 18 ] & \\ {\hat{y}}_{1} ( t ) = \frac{1}{{τ}_{Δ} s + 1} {q}_{{\hat{y}}_{1}} \vert ξ ( t ) & ( 21 )\end{matrix}$$

The unit 130 estimates the controlled variable at the time point t based on a value q_{y\hat{ }1}|ζ(t) of the disturbance at the time point t+τ_{Δ} predicted at the time point t, with Equation (21). Based on y\hat{ }₁(t) calculated with Equation (21) and the measurement value y₁(t) of the actual controlled variable and using the following Equation (22), the unit 127 calculates the variance of a difference between the estimated value and the measurement value (measured value) as in the third embodiment.

J=Var(y₁(t)−y\hat{ }1(t)) (22)

### Operation

FIG. 13 is a diagram illustrating an example of the disturbance estimation processing according to the fifth embodiment.

Through the processing described in the fourth embodiment, the estimating unit 12D predicts the disturbance q_{y\hat{ }1}|ζ converted into the controlled variable at the time point t+τ_{Δ} (step S20). Next, the unit 130 estimates the controlled variable at the time point t (step S21). As described above, the predicted value q_{y\hat{ }1}|ζ(t) of the disturbance represents the controlled variable y\hat{ }1(t+τ_{Δ}) at the time point t+τ_{Δ}. With Equation (21), the unit 130 performs calculation to go back through time, and estimates the controlled variable y\hat{ }₁(t) at the time point t based on the controlled variable y\hat{ }1(t+τ_{Δ}). Next, the unit 126 calculates an error between the estimated value of the controlled variable at the time point t and the actual controlled variable (step S22). Next, the unit 127 calculates the variance J of the error calculated in step S22 (step S23). The unit 127 calculates the variance J with Equation (22). Next, the unit 128 determines the accuracy of the estimation of the controlled variable y\hat{ }₁(t), based on the variance J of the error calculated in step S23 (step S24). The unit 128 determines that the estimation is inaccurate when the variance J is larger than a predetermined threshold value, and determines that the estimation is accurate when the variance J is smaller than the predetermined threshold value. As illustrated in FIG. 12, a hysteresis width may be provided for this determination. With the hysteresis width provided, the measurement error or variation in the controlled variable y₁ can be absorbed, whereby stable control can be performed. The unit 128 sets the adjustment limitation instruction to ON when the estimation is determined to be inaccurate, and sets the adjustment limitation instruction to OFF when the estimation is determined to be accurate. The estimating unit 12D outputs the predicted value y\hat{ }₁ of the controlled variable and the adjustment limitation instruction (ON or OFF) to the control device 20 (step S25).

In step S24, when a situation where the adjustment limitation instruction is ON continues, the estimating unit 12D may attempt to increase the accuracy, such as increasing the frequency of updating Q₀ and uᵢ described with reference to FIG. 4. When the accuracy does not increase despite such an attempt, a measurement value may be reselected that is used as a second element or after in the measurement vector z^{˜} used for calculating the estimated value q_{y\hat{ }1}|ζ, or the delay time may be reset.

With the present embodiment, in addition to the effects achieved by the fourth embodiment, the controlled object 30 can be controlled while checking the prediction accuracy of the disturbance predicted value q_{y\hat{ }1}|ζ. Furthermore, the control device 20 is provided with the function of automatically switching, based on the value of the adjustment limitation instruction, between the executing and stopping of the adjustment based on the disturbance predicted value q_{y\hat{ }1}|ζ, whereby the accuracy of control by the control device 20 can be ensured.

### Sixth Embodiment

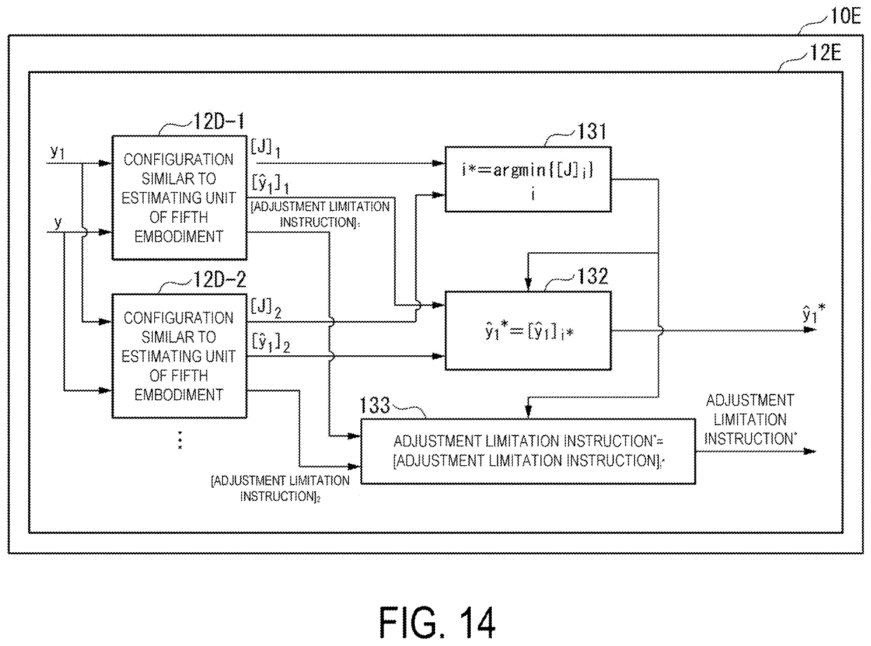

A disturbance estimation device 10E according to a sixth embodiment will be described with reference to FIG. 14.

The singular vector u₁∈R^{m} is important for the disturbance estimation of the present disclosure. The singular vector u₁ is updated once in every cycle T_{B} in accordance with a delay time {τ₁, τ₂, . . . , τₘ} designated in advance. The value of the singular vector is changed by each update. The changed value may be used as is. Still, for example, when a majority method is employed with a plurality of singular vectors calculated and the most favorable one of the vectors used, the reliability of the disturbance estimation is expected to be increased compared with the case where only a singular vector is used. The same applies to the delay time. For example, based on the operation mode of the controlled object 30 (when the object is started, during rated operation, during low output operation), a change in the type of measurement value affected by the disturbance or the like may occur. In view of this, in the sixth embodiment, the prediction accuracy is determined for the controlled variable using the method according to the fifth embodiment for each of various different update timings of the singular vector, delay times, measurement values forming the measurement vector y, and the like. Then, the controlled object 30 is controlled using the controlled variable with the highest accuracy.

### Configuration

FIG. 14 is a diagram illustrating an example of a functional configuration of a main part of the disturbance estimation device according to the sixth embodiment.

The disturbance estimation device 10E according to the sixth embodiment includes: a plurality of the estimating units 12D according to the fifth embodiment; a selection unit 131 that selects the smallest one of the variances J respectively calculated by the plurality of estimating units 12D; a selection unit 132 that selects the predicted value y\hat{ }₁ of the controlled variable corresponding to the variance J selected by the selection unit 131; and a selection unit 133 that selects the adjustment limitation instruction corresponding to the variance J selected by the selection unit 131. The output unit 13 of the sixth embodiment outputs the predicted value y\hat{ }₁ of the controlled variable selected by the selection unit 132, and the adjustment limitation instruction selected by the selection unit 133.

For example, as illustrated in FIG. 14, estimating units 12D-1 and 12D-2 are provided, and the selection unit 131 selects the smaller one of the variances [J]₁ and [J]₂ of a difference between the predicted value of the controlled variable and the actual controlled variable in consideration of a variation in the controlled variable due to the disturbance estimated by the respective estimating units. Then, the number with the smallest variance is selected as i* (Equation (23)).

$$\begin{matrix}[ Equation 19 ] & \\ {i}^{*} = arg {min}_{i} \{ {[ J ]}_{i} \} & ( 23 )\end{matrix}$$

The output from the estimating unit 12D of the number i* is selected as the estimated value y\hat{ }_{i*} of the variation in the controlled variable and the adjustment limitation instruction * respectively by the selection unit 132 and the selection unit 133, to be output to the control device 20 by the output unit 13.

With the present embodiment, the reliability of the disturbance estimation can be improved. The estimating unit 12E may include a plurality of estimating units 12D with different values set for the cycle T_{B} at which the singular vector of the variance-covariance matrix Q₀ of the measurement vector y is updated, may include a plurality of estimating units 12D with different values set for the delay time of the controlled variable until the disturbance appears as a variation in the value of the controlled variable, may include a plurality of estimating units 12D that perform disturbance estimation based on a plurality of different types of the measurement vector y, and may include a plurality of estimating units 12D with various different values set for at least two or three of these three parameters.

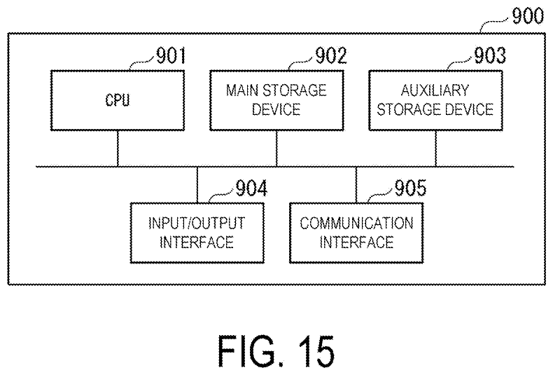

FIG. 15 is a diagram illustrating an example of a hardware configuration of the disturbance estimation devices according to the embodiments.

A computer 900 includes a CPU 901, a main storage device 902, an auxiliary storage device 903, an input/output interface 904, and a communication interface 905.

The disturbance estimation devices 10 to 10E described above are installed in the computer 900. The functions described above are stored in the auxiliary storage device 903 in a format of a program. The CPU 901 reads the program from the auxiliary storage device 903, develops the program to the main storage device 902, and executes the above-mentioned processing in accordance with the program. The CPU 901 secures a storage area in the main storage device 902 in compliance with the program. The CPU 901 secures a storage area for storing data under processing in the auxiliary storage device 903 in compliance with the program.

Note that a program for implementing the whole or part of the functions of the disturbance estimation devices 10 to 10E may be recorded in a computer readable recording medium, and a computer system may be caused to read and execute the program recorded in the recording medium to execute the processing of the respective functional units. The “computer system” here includes hardware such as an operating system (OS) or peripheral equipment. In addition, if a world wide web (WWW) system is used, the “computer system” also includes a home page providing environment (or a display environment). The “computer readable recording medium” refers to a portable medium such as a CD, a DVD, or a USB, or a storage device such as a hard disk built in a computer system. Further, when this program is distributed to the computer 900 through a communication line, the computer 900 receiving the distribution may develop the program to the main storage device 902, and may execute the above-mentioned processing. The above-described program may implement part of the functions described above, and furthermore, also implement the functions described above in combination with a program already recorded in the computer system.

In the foregoing, certain embodiments of the present disclosure have been described, but all of these embodiments are merely illustrative and are not intended to limit the scope of the disclosure. These embodiments may be implemented in various other forms, and various omissions, substitutions, and alterations may be made without departing from the gist of the disclosure. These embodiments and modifications are included in the scope and gist of the disclosure and are also included in the scope of the disclosure described in the claims and equivalents thereof.

### Notes

The disturbance estimation devices 10 to 10E, the disturbance estimation method, and the program described in the embodiments can be understood as follows, for example.

(1) The disturbance estimation devices 10 to 10E according to a first aspect include: the acquisition unit 11 configured to acquire a measurement value measured by a sensor provided in a controlled object; and the estimating unit 12 configured to calculate a variance-covariance matrix of a measurement vector including the measurement value as an element, perform singular value decomposition on the variance-covariance matrix to calculate a singular vector of a maximum singular value, and estimate a disturbance occurring in the controlled object based on the singular vector and the measurement vector.

In this way, the disturbance that occurs in the controlled object can be estimated based on the measurement value measured by the sensor provided in the controlled object (first embodiment).

(2) The disturbance estimation devices 10A to 10E according to a second aspect are the disturbance estimation devices 10A to 10E in (1), in which the acquisition unit acquires a measurement value of a controlled variable that is a variable as a target of control on the controlled object, and the estimating unit estimates the disturbance as a variation in the controlled variable, based on the singular vector of the maximum singular value in the measurement vector (Equation (13)).

In this way, the disturbance converted into a variation in a controlled variable can be estimated, and thus, the magnitude of the disturbance can be estimated even if the dominant disturbance is not known in advance (second embodiment).

(3) The disturbance estimation devices 10B and 10C according to a third aspect are the disturbance estimation devices 10B and 10C in (1) and (2), in which based on a magnitude of variance of the disturbance estimated, the estimating unit performs determination on accuracy of the disturbance estimated, and outputs a result of the determination as well as the disturbance estimated.

In this way, the accuracy of the disturbance estimation can be determined. For example, the controlled object is controlled without using the estimation result when the accuracy is low, and thus the accuracy of control can be ensured (third embodiment).

(4) The disturbance estimation devices 10C and 10D according to a fourth aspect are the disturbance estimation devices 10C and 10D in (1) to (3), in which the estimating unit includes a correction unit configured to correct a delay time until the disturbance appears as a variation in the measurement value, and the estimating unit corrects, using the correction unit, the delay time of the measurement value acquired by the acquisition unit, and estimates the disturbance using the measurement vector including the measurement value after the correction as an element.

Generally, a disturbance that has occurred in the controlled object appears as a variation in a controlled variable or a measurement value after a time delay. According to the fourth aspect, the estimation accuracy of the disturbance can be improved by the disturbance is estimated in consideration of the time delay (fourth embodiment).

(5) The disturbance estimation device 10D according to a fifth aspect is the disturbance estimation device 10D in (4), in which the estimating unit estimates an estimated value of the measurement value with a longest delay time among a plurality of the measurement values based on the disturbance estimated, performs determination on accuracy of the disturbance estimated based on variance in a difference between the estimated value of the measurement value and a measured value of the measurement value, and outputs a result of the determination as well as the estimated value of the measurement value estimated.

In this way, the disturbance is converted into a variation in the controlled variable and compared with the measured value of the controlled variable to determine the accuracy of the disturbance estimation. Thus, the accuracy of control using the disturbance can be ensured (fifth embodiment).

(6) The disturbance estimation device 10E according to a sixth aspect is the disturbance estimation device 10D in (5), further including a plurality of the estimating units, and in which a disturbance estimated by one of the estimating units with highest accuracy of the disturbance is selected.

In this way, the disturbance estimated with the highest accuracy can be used for control (sixth embodiment).

(7) The disturbance estimation device 10E according to a seventh aspect is the disturbance estimation device 10E in (6), in which each of the plurality of the estimating units estimates the disturbance based on the measurement value different from the measurement value used by another estimating unit, performs correction of the delay time different from correction of the delay time by another estimating units and estimates the disturbance, or updates the variance-covariance matrix and the singular vector at a cycle different from a cycle of another estimating units and estimates the disturbance.

Estimating the disturbance under various conditions can increase the likelihood that the disturbance estimation can be performed accurately.

(8) A disturbance estimation method according to an eighth aspect includes: acquiring a measurement value measured by a sensor provided in a controlled object; and calculating a variance-covariance matrix of a measurement vector including the measurement value as an element, performing singular value decomposition on the variance-covariance matrix to calculate a singular vector of a maximum singular value, and estimating a disturbance occurring in the controlled object based on the singular vector and the measurement vector.

(9) A non-transitory computer readable storage medium storing a program according to a ninth aspect causes a computer to perform: acquiring a measurement value measured by a sensor provided in a controlled object; and calculating a variance-covariance matrix of a measurement vector including the measurement value as an element, performing singular value decomposition on the variance-covariance matrix to calculate a singular vector of a maximum singular value, and estimating a disturbance that occurs in the controlled object based on the singular vector and the measurement vector.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A disturbance estimation device comprising:
an acquisition unit configured to acquire a measurement value measured by a sensor provided in a controlled object; and
an estimating unit configured to calculate a variance-covariance matrix of a measurement vector including the measurement value as an element, perform singular value decomposition on the variance-covariance matrix to calculate a singular vector of a maximum singular value, and estimate a disturbance occurring in the controlled object based on the singular vector and the measurement vector.

2. The disturbance estimation device according to claim 1, wherein
the acquisition unit acquires a measurement value of a controlled variable that is a variable as a target of control on the controlled object, and
the estimating unit estimates the disturbance as a variation in the controlled variable, based on the singular vector of the maximum singular value in the measurement vector.

3. The disturbance estimation device according to claim 1, wherein based on a magnitude of variance of the disturbance estimated, the estimating unit performs determination on accuracy of the disturbance estimated, and outputs a result of the determination as well as the disturbance estimated.

4. The disturbance estimation device according to claim 1, wherein
the estimating unit includes a correction unit configured to correct a delay time until the disturbance appears as a variation in the measurement value, and
the estimating unit corrects, using the correction unit, the delay time of the measurement value acquired by the acquisition unit, and estimates the disturbance using the measurement vector including the measurement value after the correction as an element.

5. The disturbance estimation device according to claim 4, wherein the estimating unit estimates an estimated value of the measurement value with a longest delay time among a plurality of the measurement values based on the disturbance estimated, performs determination on accuracy of the disturbance estimated based on variance in a difference between the estimated value of the measurement value and a measured value of the measurement value, and outputs a result of the determination as well as the estimated value of the measurement value estimated.

6. The disturbance estimation device according to claim 5, further comprising a plurality of the estimating units, and wherein
a disturbance estimated by one of the estimating units with highest accuracy of the disturbance is selected.

7. The disturbance estimation device according to claim 6, wherein each of the plurality of the estimating units estimates the disturbance based on the measurement value different from the measurement value used by another estimating unit, performs correction of the delay time different from correction of the delay time by another estimating unit and estimates the disturbance, or updates the variance-covariance matrix and the singular vector at a cycle different from a cycle of another estimating unit and estimates the disturbance.

8. A disturbance estimation method comprising:
acquiring a measurement value measured by a sensor provided in a controlled object; and
calculating a variance-covariance matrix of a measurement vector including the measurement value as an element, performing singular value decomposition on the variance-covariance matrix to calculate a singular vector of a maximum singular value, and estimating a disturbance occurring in the controlled object based on the singular vector and the measurement vector.

9. A non-transitory computer readable storage medium storing a program for causing a computer to perform:
acquiring a measurement value measured by a sensor provided in a controlled object; and
calculating a variance-covariance matrix of a measurement vector including the measurement value as an element, performing singular value decomposition on the variance-covariance matrix to calculate a singular vector of a maximum singular value, and estimating a disturbance occurring in the controlled object based on the singular vector and the measurement vector.
